(19) United States
(12) Patent Application Publication
(10) Pub. No.: US 2015/0219088 A1
(43) Pub. Date: Aug. 6, 2015

(54) LIQUID TRANSPORT APPARATUS

(71) Applicant: SEIKO EPSON CORPORATION, Tokyo (JP)

(72) Inventor: Tsutomu MIYAMOTO, Shiojiri-shi (JP)

(21) Appl. No.: 14/609,724

(22) Filed: Jan. 30, 2015

(30) Foreign Application Priority Data
Jan. 31, 2014 (JP) 2014-016649

(51) Int. Cl. F04B 43/12; F04B 51/00; F04B 53/00; G01D 5/26

(52) U.S. Cl. CPC F04B 43/12; G01D 5/26; F04B 51/00; F04B 53/00

(57) ABSTRACT

A liquid transport apparatus includes: a flow channel forming member; a cam; a pressing member; a rotor configured to be rotated; a decelerating unit configured to transmit the rotation to the cam; a cam-side measuring unit configured to output a cam-side reference signal indicating the fact that the cam reaches a predetermined rotational angle; a first measuring unit configured to output a first signal when the rotor rotates; a second measuring unit configured to output a second signal indicating the fact that the rotor reaches a predetermined rotational angle; and a determining unit configured to determine a reference of the first signal on the basis of the second signal output after an output of the cam-side reference signal. The liquid transport apparatus is capable of determining a signal original point without variations to obtain a relationship between the signal original point and a pump original point easily.

### BACKGROUND

1. Technical Field

The present invention relates to a liquid transport apparatus.

2. Related Art

A micro pump disclosed in JP-A-2013-24185 is known as a liquid transport apparatus configured to transport liquid. The micro pump includes a plurality of fingers arranged along a tube, and a cam presses the fingers in sequence, so that the tube is collapsed and hence liquid is transported. An encoder for measuring a rotational angle of the cam is provided.

In a liquid transport using the cam and the fingers, liquid feeding properties include periodicity. Although a signal output from the encoder has periodicity, a position of a reference point of an output signal (hereinafter, referred to as “signal original point”) in one cycle differs from one machine to another. Therefore, it is required to obtain a relationship between the signal original point and a rotational angle as a reference of the cam (hereinafter, referred to as “pump original point”) in advance in order to control the liquid transport.

However, since a rotating speed of the cam is slow, a change in time of the output signal from the encoder is gentle, and hence the signal original point cannot be determined to one, and hence a relationship between the signal original point and the pump original point cannot be obtained easily.

### SUMMARY

An advantage of some aspects of the invention is to determine a signal original point without variations in order to obtain a relationship between the signal original point and a pump original point easily.

An aspect of the invention provides a liquid transport apparatus including: a flow channel forming member configured to form a flow channel in which liquid is transported; a cam; a pressing member arranged between the flow channel forming member and the cam, and configured to press the flow channel forming member; a rotor configured to be rotated by a drive force of an actuator; a decelerating unit configured to decelerate a rotation of the rotor and transmit the decelerated rotation to the cam; a cam-side measuring unit configured to output a cam-side reference signal indicating the fact that the cam reaches a predetermined rotational angle; a first measuring unit configured to output a first signal when the rotor rotates; a second measuring unit configured to output a second signal indicating the fact that the rotor reaches a predetermined rotational angle; and a determining unit configured to determine a reference of the first signal on the basis of the second signal output after an output of the cam-side reference signal.

Other characteristics of the aspects of the invention will be apparent from the specification and attached drawings.

### BRIEF DESCRIPTION OF DRAWINGS

The invention will be described with reference to the accompanying drawings, wherein like numbers reference like elements.

FIG. 1 is a general perspective view of a liquid transport apparatus.

FIG. 2 is an exploded view of the liquid transport apparatus.

FIG. 3 is a cross-sectional view of the liquid transport apparatus.

FIG. 4 is a perspective top view of the interior of the liquid transport apparatus.

FIG. 5 is a schematic explanatory drawing of a pump unit.

FIG. 6 is a block diagram for explaining a measuring unit and a control unit 50 of the liquid transport apparatus.

FIG. 7 is an explanatory drawing of a cam-side reflecting portion formed on a cam gear.

FIG. 8 is an explanatory drawing of first and second reflecting portions formed on a rotor.

FIG. 9 is a graph showing a relationship between an amount of rotation of a cam and an accumulated amount of transportation.

FIG. 10A is an explanatory drawing relating to a reverse flow of liquid.

FIG. 10B is an explanatory drawing relating to a reverse flow of liquid.

FIG. 11 is a partial enlarged drawing of the cam, the rotor, a transmitting wheel, a cam-side measuring unit, and first and second measuring units.

FIG. 12 is an explanatory drawing illustrating a relationship between signals CAM_Z, ROT_Z and ROT_A.

FIG. 13 is an explanatory drawing illustrating a relationship between the signals CAM_Z, and ROT_A.

FIG. 14 is a flowchart illustrating a procedure for specifying a signal original point.

FIG. 15 is a schematic diagram for explaining pump original point determination.

### DETAIL DESCRIPTION OF INVENTION

According to the specification and the attached drawings, at least the followings become apparent.

A liquid transport apparatus includes: a flow channel forming member configured to form a flow channel in which liquid is transported; a cam; a pressing member arranged between the flow channel forming member and the cam, and configured to press the flow channel forming member; a rotor configured to be rotated by a drive force of an actuator; a decelerating unit configured to decelerate a rotation of the rotor and transmit the decelerated rotation to the cam; a cam-side measuring unit configured to output a cam-side reference signal indicating the fact that the cam reaches a predetermined rotational angle; a first measuring unit configured to output a first signal when the rotor rotates; a second measuring unit configured to output a second signal indicating the fact that the rotor reaches a predetermined rotational angle; and a determining unit configured to determine a reference of the first signal on the basis of the second signal output after an output of the cam-side reference signal.

A liquid transport apparatus includes: a tube; a cam; a finger arranged between the tube and the cam; a drive unit having a rotor configured to be rotated by a drive force of an actuator and a decelerating unit configured to decelerate a rotation of the rotor and transmit the decelerated rotation to the cam; a cam-side measuring unit configured to output a cam-side reference signal indicating the fact that the cam reaches a predetermined rotational angle; a first measuring unit configured to output a first signal when the rotor rotates; a second measuring unit configured to output a second signal indicating the fact that the rotor reaches a predetermined rotational angle; and a determining unit configured to determine a reference of the first signal on the basis of the second signal output after an output of the cam-side reference signal.

With the liquid transport apparatus configured in the manner described above, the signal original point can be determined without variations.

It is preferable that the cam-side measuring unit outputs a pulse every time when the cam rotates by one turn. With this configuration, since the second signal is determined with reference to the pulse output from the cam-side measuring unit, the signal original point can be determined without variations.

It is preferable that the first measuring unit outputs a pulse every time when the rotor rotates at a predetermined angle, and the second measuring unit outputs a pulse every time when the rotor rotates by one turn. With this configuration, since the pulse output from the first measuring unit may be determined as a reference of the first signal on the basis of the pulse output from the second measuring unit, the signal original point can be determined without variations.

It is preferable that the liquid transport apparatus further includes: a counter configured to count on the basis of the first signal; and a memory unit configured to memorize a counted value counted by the counter from the first signal as a reference until the cam reaches a rotational angle as a reference. With this configuration, the first signal as a reference and the rotational angle as a reference of the cam may be coordinated accurately.

A liquid transport method configured to transport liquid includes: rotating a rotor; decelerating the rotation of the rotor and transmitting the decelerated rotation to a cam to rotate the cam; pressing a member that forms a flow channel of liquid in association with the rotation of the cam to transport the liquid; outputting a cam-side reference signal indicating the fact that the cam reaches a predetermined rotational angle; outputting a first signal when the rotor rotates; outputting a second signal indicating the fact that the rotor reaches a predetermined rotational angle; detecting the fact that the cam reaches the predetermined rotational angle on the basis of the cam-side reference signal; and determining a reference of the first signal on the basis of the second signal output after an output of the cam-side reference signal.

A liquid transport method configured to transport liquid including a tube; a cam; a finger arranged between the tube and the cam; a drive unit having a rotor configured to be rotated by a drive force of an actuator and a decelerating unit configured to decelerate a rotation of the rotor and transmit the decelerated rotation to the cam; a cam-side measuring unit configured to output a cam-side reference signal indicating the fact that the cam reaches a predetermined rotational angle; a first measuring unit configured to output a first signal when the rotor rotates; and a second measuring unit configured to output a second signal indicating the fact that the rotor reaches a predetermined rotational angle, includes: driving the actuator to rotate the rotor and the cam; detecting the fact that the cam reaches the predetermined rotational angle on the basis of the cam-side reference signal of the cam-side measuring unit; and determining a reference of the first signal on the basis of the second signal output after an output of the cam-side reference signal. With the liquid transport method configured in this manner, the signal original point can be determined without variations.

A method of determining a cam original point for an apparatus configured to transport liquid includes: rotating a rotor; decelerating the rotation of the rotor and transmitting the decelerated rotation to a cam to rotate the cam; pressing a member that forms a flow channel of liquid in association with the rotation of the cam to transport the liquid; outputting a cam-side reference signal indicating the fact that the cam reaches a predetermined rotational angle; outputting a first signal when the rotor rotates; outputting a second signal indicating the fact that the rotor reaches a predetermined rotational angle; detecting the fact that the cam reaches the predetermined rotational angle on the basis of the cam-side reference signal; and determining a reference of the first signal on the basis of the second signal output after an output of the cam-side reference signal.

A method of determining a cam original point of an apparatus for transporting liquid including a tube; a cam; a finger arranged between the tube and the cam; a drive unit having a rotor configured to be rotated by a drive force of an actuator and a decelerating unit configured to decelerate a rotation of the rotor and transmit the decelerated rotation to the cam; a cam-side measuring unit configured to output a cam-side reference signal indicating the fact that the cam reaches a predetermined rotational angle; a first measuring unit configured to output a first signal when the rotor rotates; and a second measuring unit configured to output a second signal indicating the fact that the rotor reaches a predetermined rotational angle, includes: driving the actuator to rotate the rotor and the cam; detecting the fact that the cam reaches the predetermined rotational angle on the basis of the cam-side reference signal of the cam-side measuring unit; and determining a reference of the first signal on the basis of the second signal output after an output of the cam-side reference signal. With the method of determining the cam original point as described above, the signal original point of the liquid transport apparatus may be determined without variations.

### EMBODIMENTS

### Liquid Transport Apparatus

### General Configuration

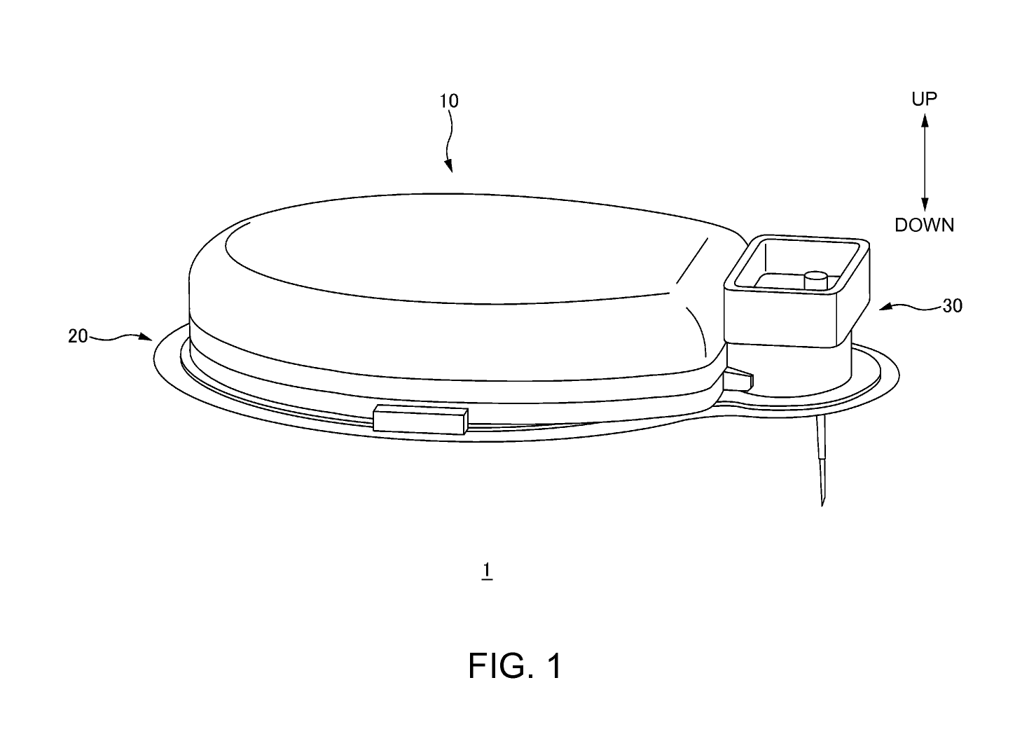

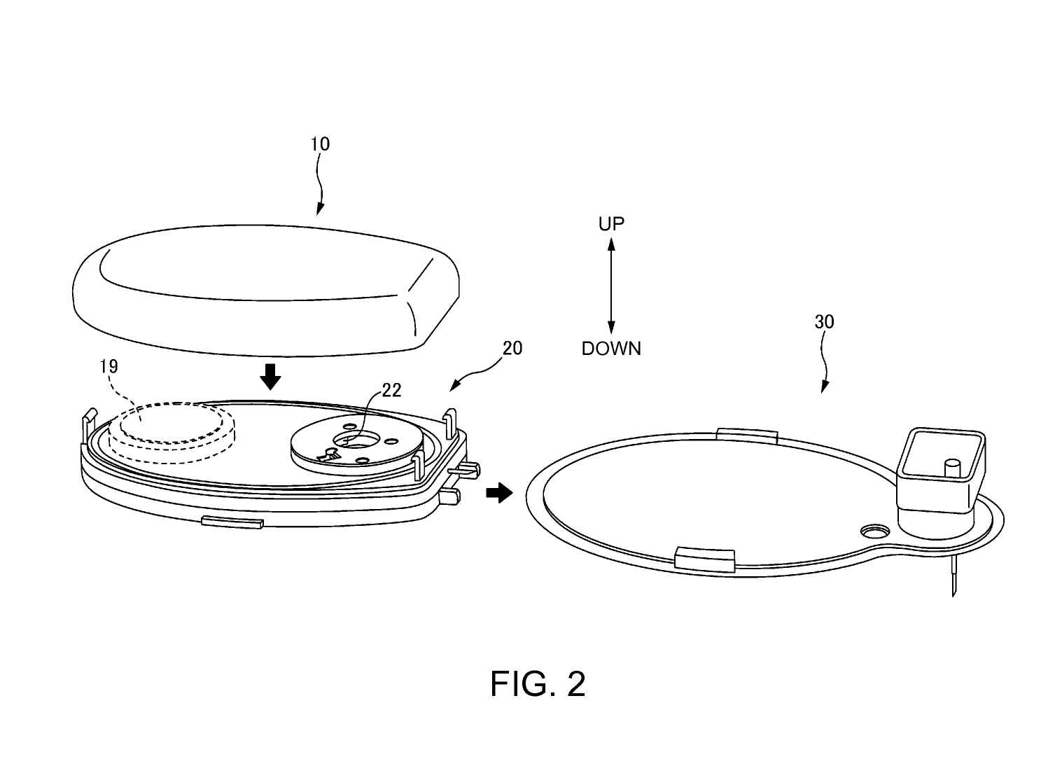

FIG. 1 is a general perspective view of a liquid transport apparatus 1. FIG. 2 is an exploded view of the liquid transport apparatus 1. As illustrated in these drawings, a side (biological body side) where the liquid transport apparatus 1 is adhered is referred to as “down” and an opposite side may be referred to as “up” in the description.

The liquid transport apparatus 1 is an apparatus configured to transport liquid. The liquid transport apparatus 1 includes a main body 10, a cartridge 20, and a patch 30. The main body 10, the cartridge 20, and the patch 30 are separable as illustrated in FIG. 2, and are assembled integrally when in use as illustrated in FIG. 1. The liquid transport apparatus 1 is preferably used for infusing liquid stored in the cartridge 20 (for example, insulin) regularly, for example by adhering the patch 30 to the biological body. In the case where the liquid stored in the cartridge 20 is finished up, the cartridge 20 is replaced. However, the main body 10 and the patch 30 are continuously used.

### Pump Unit

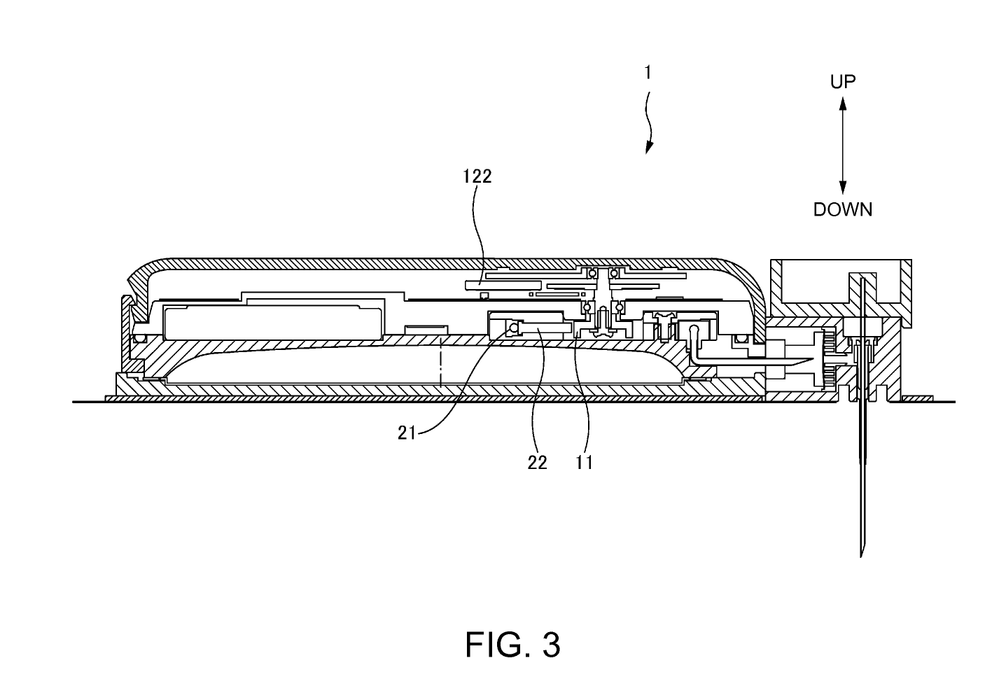

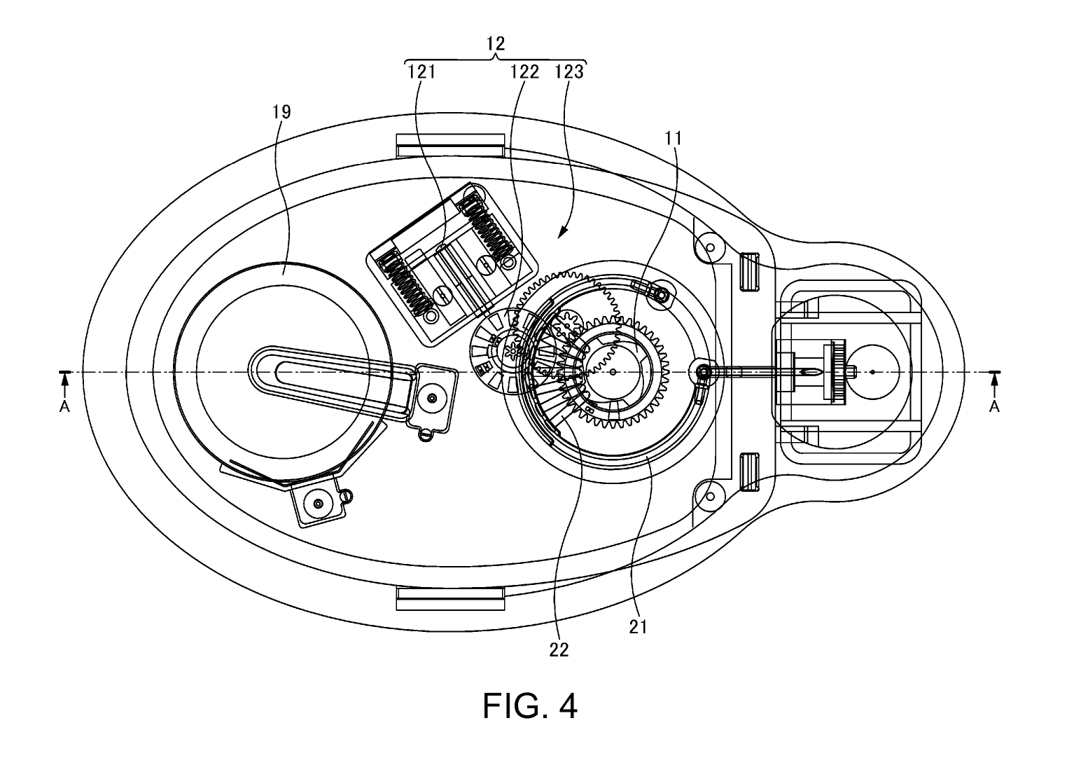

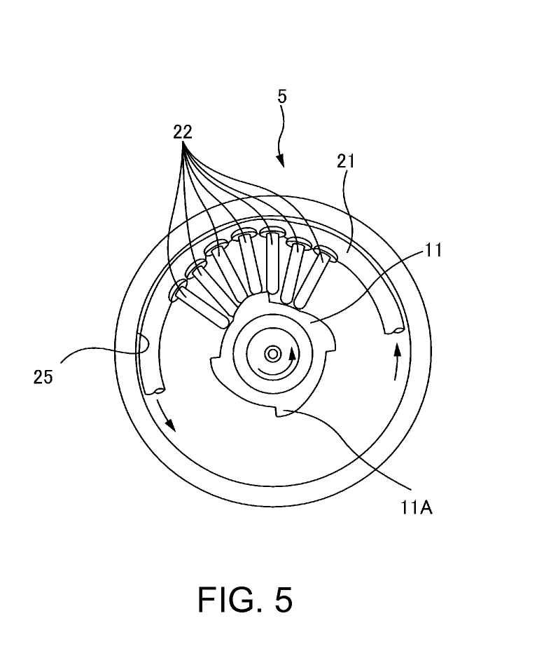

FIG. 3 is a cross-sectional view of the liquid transport apparatus 1. FIG. 4 is a perspective top view of an interior of the liquid transport apparatus 1, and also illustrates a configuration of a pump unit 5. FIG. 5 is a schematic explanatory drawing of the pump unit 5.

The pump unit 5 has a function as a pump for transporting liquid stored in the cartridge 20, and includes a tube 21, a plurality of fingers 22, a cam 11, and a drive mechanism 12.

The tube 21 is a tube for transporting liquid. An upstream side of the tube 21 (the upstream side with reference to a direction of transport of the liquid) communicates with a storage portion of the liquid in the cartridge 20. The tube 21 has a resiliency to an extent to close when pressed by the fingers 22 and restore when a force from the fingers 22 is released. The tube 21 is arranged in a partially arcuate shape along an inner surface of a tube guide wall 25 of the cartridge 20. The arcuate portion of the tube 21 is arranged between the inner surface of the tube guide wall 25 and the plurality of fingers 22. A center of the arc of the tube 21 matches a center of rotation of the cam 11.

The fingers 22 are members for closing the tube 21. The fingers 22 operate upon reception of a force from the cam 11. The fingers 22 each include a rod-shaped shaft portion and a flange-shaped pressing portion and is formed into a T-shape. The rod-shaped shaft portion comes into contact with the cam 11, and the flange-shaped pressing portion comes into contact with the tube 21. The fingers 22 are supported so as to be movable along an axial direction.

The plurality of fingers 22 are arranged radially from the center of rotation of the cam 11 at regular distance. The plurality of fingers 22 are arranged between the cam 11 and the tube 21. Here seven fingers 22 are provided. In the following description, the fingers may be referred to as a first finger 22A, a second finger 22B . . . , and a seventh finger 22G from the upstream side of the direction of transport of the liquid.

The cam 11 has projecting portions 11A at four positions on an outer periphery thereof. The plurality of fingers 22 are arranged on the outer periphery of the cam 11, and the tube 21 is arranged on the outside of the fingers 22. The fingers 22 are pressed by the projecting portions 11A of the cam 11, so that the tube 21 is closed. When the fingers 22 come out of contact with the projecting portions 11A, the tube 21 is restored to the original shape by resiliency of the tube 21. When the cam 11 rotates, the seven fingers 22 are pressed in sequence by the projecting portions 11A, and close the tube 21 in sequence from the upstream side in the direction of transport. Accordingly, when the tube 21 is caused to perform a peristaltic action, and liquid is compressed and transported to the tube 21.

### Drive Mechanism

The drive mechanism 12 is a mechanism configured to drive the cam 11 to rotate and, as illustrated in FIG. 4, includes a piezoelectric actuator 121, a rotor 122, and a deceleration transmitting mechanism 123.

The piezoelectric actuator 121 is an actuator for rotating the rotor 122 by using vibrations of a piezoelectric element. The piezoelectric actuator 121 vibrates a vibrator by applying a drive signal on the piezoelectric elements adhered to both surfaces of the rectangular vibrator. An end portion of the vibrator comes into contact with the rotor 122, and when the vibrator vibrates, the end portion vibrates while tracing out a predetermined orbit such as an oval orbit or a figure eight orbit. By the end portion of the vibrator coming into contact with the rotor 122 at a portion of the vibration orbit, the rotor 122 is driven to rotate. The piezoelectric actuator 121 is biased toward the rotor 122 by a pair of springs so that the end portion of the vibrator comes into contact with the rotor 122.

The rotor 122 is a driven member rotated by the piezoelectric actuator 121. The rotor 122 is provided with a rotor pinion which constitutes part of the deceleration transmitting mechanism 123.

The deceleration transmitting mechanism 123 is a mechanism configured to transmit a rotation of the rotor 122 to the cam 11 at a predetermined gear ratio. The deceleration transmitting mechanism 123 includes the rotor pinion, a transmitting wheel 123A, and a cam gear (see FIG. 11). The rotor pinion is a small gear integrally mounted on the rotor 122. The transmitting wheel 123A includes a large gear that engages the rotor pinion and a pinion that engages the cam gear, and has a function to transmit a rotational force of the rotor 122 to the cam 11. The cam gear is integrally mounted on the cam 11, and is rotatably supported together with the cam 11. The gear ratio of the deceleration transmitting mechanism 123 is set to 40 here. In other words, when the rotor 122 rotates by one turn, the cam 11 rotates by 1/40 turn.

The pump unit 5 includes the tube 21, the plurality of fingers 22, the cam 11 and the drive mechanism 12, and the cam 11 and the drive mechanism 12 are provided on the main body 10, and the tube 21 and the plurality of fingers 22 are provided on the cartridge 20. The main body 10 is provided with a measuring unit 40 configured to measure the rotational angle of the cam 11 or the like, a control unit 50 configured to control the piezoelectric actuator 121 or the like, and a battery 19 configured to supply power to the piezoelectric actuator 121 or the like.

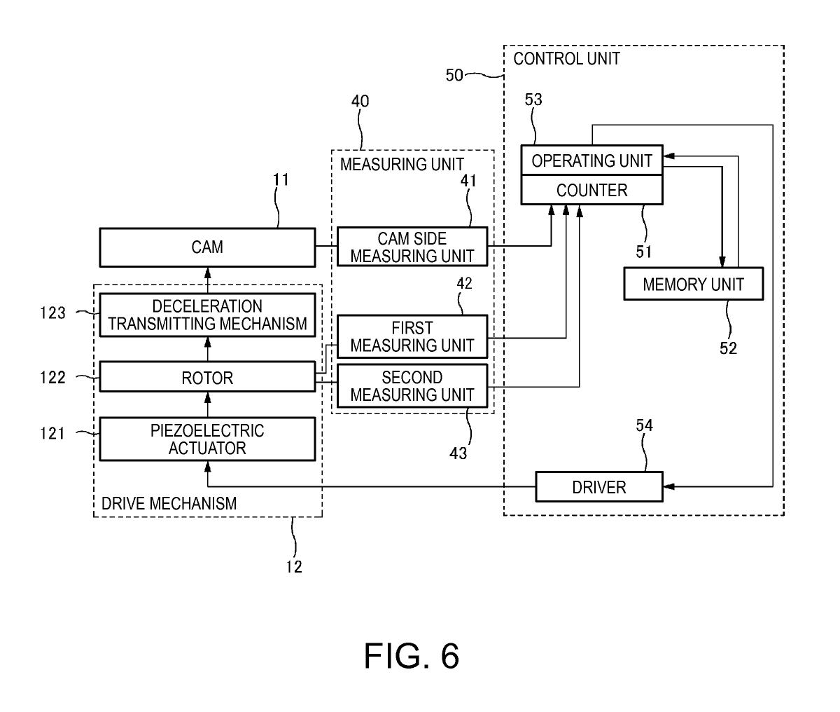

FIG. 6 is a block diagram for explaining the measuring unit 40 and the control unit 50 of the liquid transport apparatus 1. While referring to FIG. 11 as well, the measuring unit 40 and the control unit 50 will be described.

The measuring unit 40 includes a cam-side measuring unit 41 for measuring the rotational angle of the cam 11, and first and second measuring units 42 and 43 configured to measure first and second rotational angles of the rotor 122.

The cam-side measuring unit 41 is a rotary-type encoder including a light-emitting portion 41A and a light-receiving portion 41B. The cam gear is provided with a cam-side reflecting portion 111 formed thereon, and the cam-side reflecting portion 111 reflects light from the light-emitting portion 41A and the light-receiving portion 41B receives the reflected light. The light-receiving portion 41B outputs an output signal CAM_Z in accordance with an amount of received light to the control unit 50.

The first and second measuring units 42 and 43 are also rotary-type encoders provided with light-emitting portions 42A and 43A and light-receiving portions 42B and 43B. The rotor 122 is provided with first and second reflecting portions 124 and 125 formed thereon. The first reflecting portions 124 reflect light from the light-emitting portion 42A of the first measuring unit 42 and the light-receiving portion 42B of the first measuring unit 42 receives the reflected light. The second reflecting portion 125 reflects light from the light-emitting portion 43A of the second measuring unit 43, and the light-receiving portion 43B of the second measuring unit 43 receives the reflected light. The light-receiving portions 42B and 43B of the first and second measuring units 42 and 43 output signals ROT_A and ROT_Z in accordance with the amount of received light to the control unit 50, respectively.

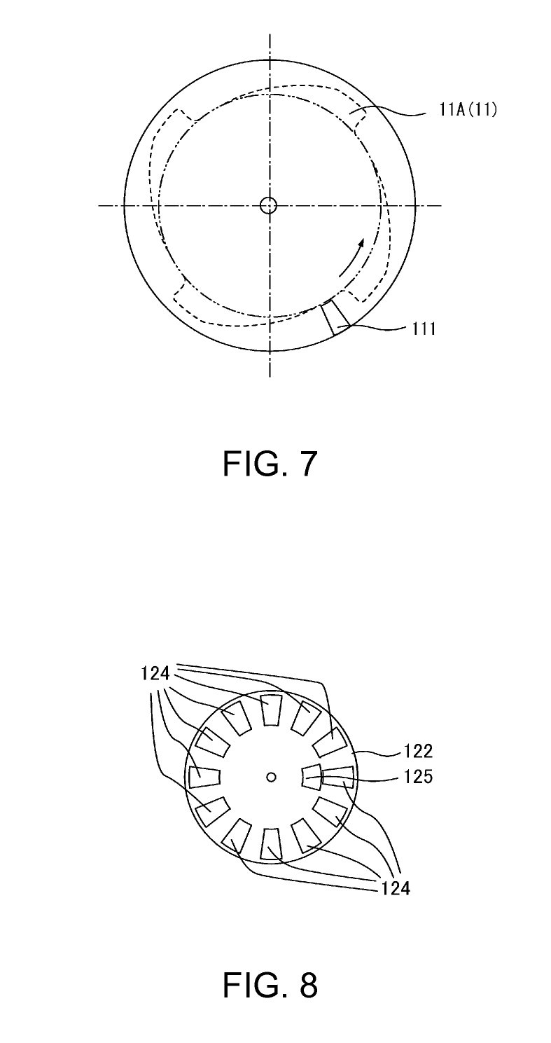

FIG. 7 is an explanatory drawing of the cam-side reflecting portion 111 formed on the cam gear. As illustrated in FIG. 7, one cam-side reflecting portion 111 is formed on the cam gear. A positional relationship of the cam-side reflecting portion 111 with respect to the projecting portions 11A differs from one product to another.

FIG. 8 is an explanatory drawing of the first and second reflecting portions 124 and 125 formed on the rotor 122. As illustrated in FIG. 8, the numbers of the first and second reflecting portions 124 and 125 are twelve and one, respectively. The twelve first reflecting portions 124 are formed radially about a rotating shaft of the rotor 122 equidistantly at regular intervals. Therefore, an angle between the first reflecting portions 124 is 30 degrees. The second reflecting portion 125 is formed solely on an inner side of the first reflecting portions 124, that is, on the rotating shaft side of the rotor 122.

The cam-side measuring unit 41 and the first and second measuring units 42 and 43 are not limited to a reflective optical sensor, but may be a transmissive optical sensor.

The control unit 50 includes a counter 51, a memory unit 52, an operating unit 53, and a driver 54 as illustrated in FIG. 6. The counter 51 counts the number of edges included in the output signal ROT_A from the first measuring unit 42. The counted value of the counter 51 indicates the rotational angle of the rotor 122. Since the rotational angle of the rotor 122 and the rotational angle of the cam 11 correspond to each other, the counted value of the counter 51 indicates also the rotational angle of the cam 11. The memory unit 52 memorizes a program used by the operating unit 53 for driving the driver 54, and memorizes a position on the output signal ROT_A corresponding to the pump original point. The operating unit 53 executes the program memorized in the memory unit 52, and drives the driver 54 on the basis of the counted value of the counter 51 (the rotational angles of the cam 11 and the rotor 122) and the position on the signal ROT_A corresponding to the pump original point. The driver 54 outputs a drive signal to the piezoelectric actuator 121 of the drive mechanism 12 in accordance with an instruction from the operating unit 53.

As described later, the control unit 50 corresponds to a determining unit configured to determine a reference of the output signal ROT_A on the basis of the signal ROT_Z output after an output of the signal CAM_Z.

### Actions of Liquid Transport Apparatus

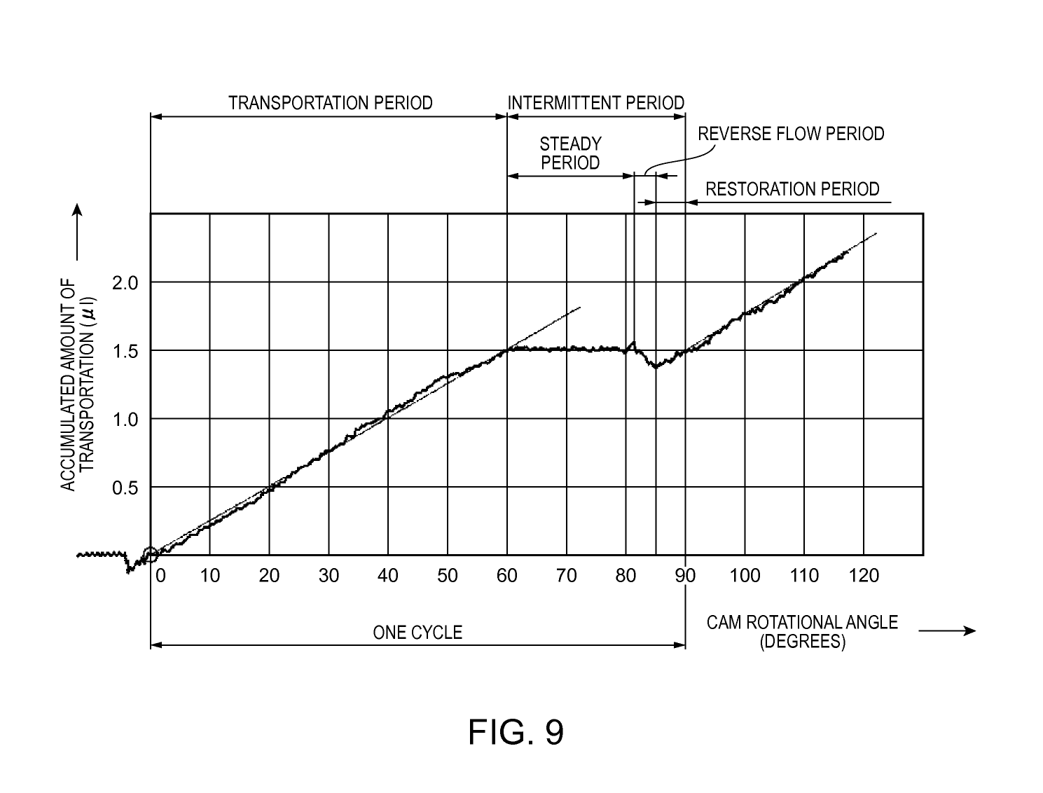

FIG. 9 is a graph showing a relationship between an amount of rotation of the cam 11 and an accumulated amount of transportation. This graph indicates a result of measurement of an accumulation of the amount of transportation with respect to the amount of rotation of the cam 11 from the reference position, which is a location of the cam 11 and is assumed to 0 degree.

Here, while the cam 11 rotates from 0 degree to 60 degrees (hereinafter, referred to as “transportation period”), the amount of transportation is substantially proportional to the rotational angle. In this transportation period, the liquid is transported by closing the tube 21 from the first finger 22A in sequence. While the cam 11 rotates from 60 degree to 80 degrees (hereinafter, referred to as “steady period”), the accumulated amount of transportation does not change. In this steady period, the seventh finger 22G continuously closes the tube 21. While the cam 11 rotates from 80 degree to 85 degrees (hereinafter, referred to as “reverse flow period”), the accumulated amount of transportation decreases. In other words, liquid flows reversely in the reverse flow period.

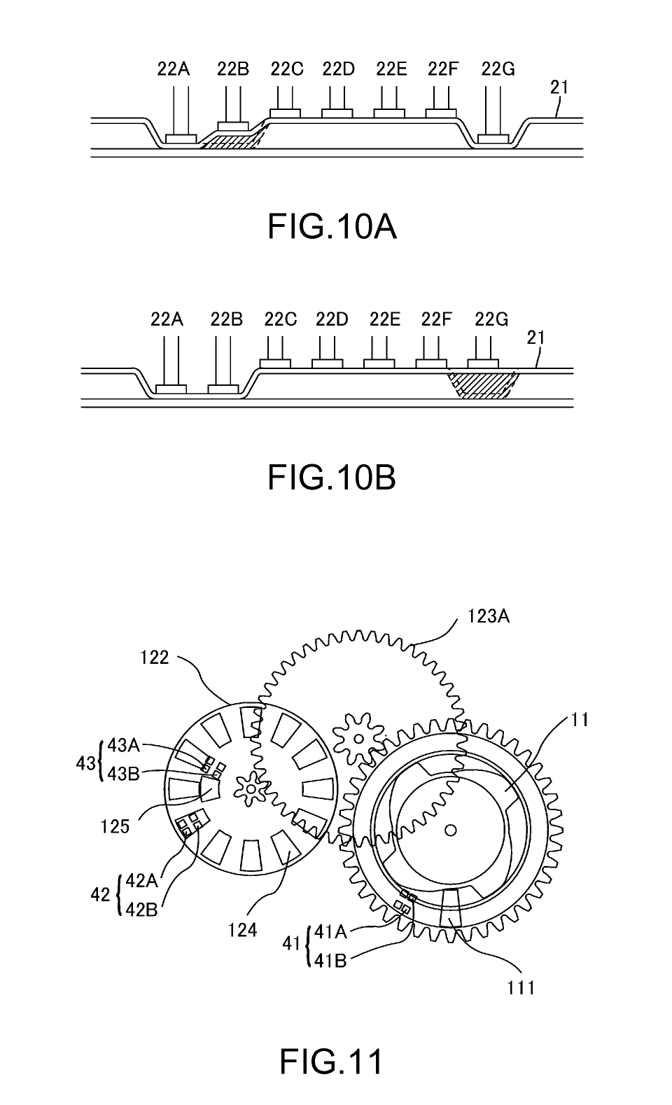

FIGS. 10A and 10B are explanatory drawings relating to a reverse flow of liquid. The tube 21 is arranged in an arcuate shape as described above. Here, however, for the sake of convenience of description, the tube 21 is illustrated as being straight.

By the rotation of the cam 11 as illustrated in FIG. 10A, a state is transferred from a state in which the seventh finger 22G closes the tube 21 to a state in which the pressed state by the seventh finger 22G is released as illustrated in FIG. 10B. At this time, liquid flows reversely by a difference in volume obtained by subtracting a volume indicated by a hatched portion in FIG. 10A from a volume indicated by a hatched portion in FIG. 10B.

While the cam 11 rotates from 85 degree to 90 degrees (hereinafter, referred to as “restoration period”), liquid of an amount corresponding to an amount of reverse flow is transported. In other words, the reference position and 0 degree correspond to the position of the cam 11 after the restoration period.

In this manner, when the cam 11 is rotated, there are a period in which liquid of an amount corresponding to the amount of rotation is transported, a period in which the liquid is not transported, and a period in which the liquid flows reversely. As a result, as illustrated in FIG. 9, the amount of transportation of the liquid with respect to the amount of rotation of the cam 11 differs depending on the rotational angle of the cam 11. For example, in the case where the liquid is transported by rotating the cam 11 by 45 degrees, the amount of transportation when the cam 11 is rotated from 0 degree to degrees (approximately 1.2 μl) and the amount of transportation when the cam 11 is rotated from 45 degrees to 90 degrees (approximately 0.3 μl) are different. In contrast, in the case where the liquid is transported by rotating the cam 11 by 90 degrees, the liquid of the substantially same amount (approximately 1.5 μl) is transported irrespective of the position of the cam 11. In other words, the amount of transportation of the liquid is non-linear with respect to the rotation of the cam 11, but has periodicity with a cycle of ¼ turn of the cam 11.

### Setting Procedure of Signal Original Point

From the viewpoint of transportation of liquid with high degree of accuracy, the accumulated amount of transportation of the liquid is preferably linear with respect to time. In order to do so, for example, the cam 11 needs to be adjusted to rotate faster in the reverse flow period and the restoration period than in the steady period. In order to do so, the counted value of the counter 51, that is, the rotational angle of the cam 11 and the amount of transportation of the liquid need to be coordinated accurately.

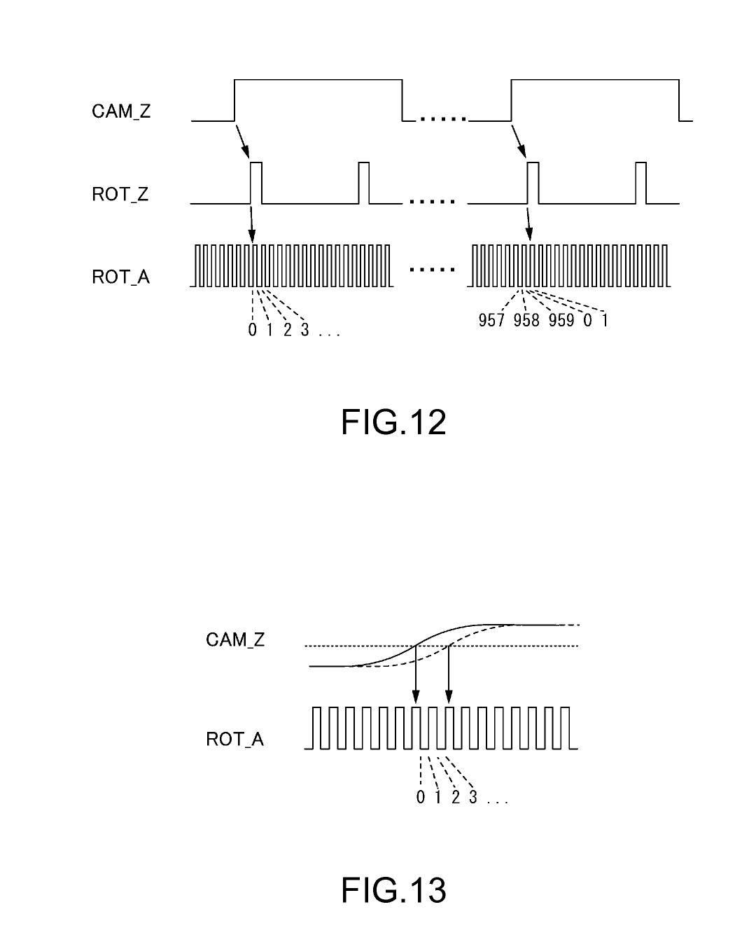

FIG. 11 is an enlarged drawing of the cam 11, the rotor 122, the transmitting wheel 123A, the cam-side measuring unit 41, and the first and second measuring units 42 and 43 in FIG. 4. FIG. 12 is an explanatory drawing illustrating a relationship between the signals CAM_Z, ROT_Z and ROT_A. FIG. is an explanatory drawing illustrating a relationship between the signals CAM_Z and ROT_A. The signals CAM_Z and ROT_A in FIG. 13 are illustrated with a time axis enlarged more than that in FIG. 12.

As described above, the first measuring unit 42 outputs the signal ROT_A in accordance with the amount of the reflected light received by the light-receiving portion 42B. Here, as illustrated in FIG. 11, the rotor 122 is provided with twelve first reflecting portions 124 in the circumferential direction. Therefore, the first measuring unit 42 outputs the signal ROT_A including twelve pulsed waveforms every time when the rotor 122 rotates by one turn.

The second measuring unit 43 outputs the signal ROT_Z in accordance with the amount of the reflected light received by the light-receiving portion 43B. Here, the rotor 122 is provided with one second reflecting portion 125. Therefore, the second measuring unit 43 outputs the signal ROT_Z including one pulsed waveform every time when the rotor 122 rotates by one turn.

As described above, the cam-side measuring unit 41 outputs the signal CAM_Z in accordance with the amount of the reflected light received by the light-receiving portion 41B. The cam 11 is provided with one cam-side reflecting portion 111 formed thereon and the cam-side measuring unit 41 outputs the signal CAM_Z including one pulsed waveform every time when the cam 11 rotates by one turn.

Here, since the rotor 122 rotates by 40 turns while the cam 11 rotates by one turn, the number of pulses included in the output signal ROT_A of the first measuring unit 42 corresponding to the rotor 122 in one cycle of the output signal CAM_Z of the cam-side measuring unit 41 is 40×12=480. If a leading edge and a fall edge of pulses of the signal ROT_A are determined to be one count respectively, 960 counts from 0 to 959 are measured every time when the cam 11 rotates by one turn as illustrated in FIG. 12.

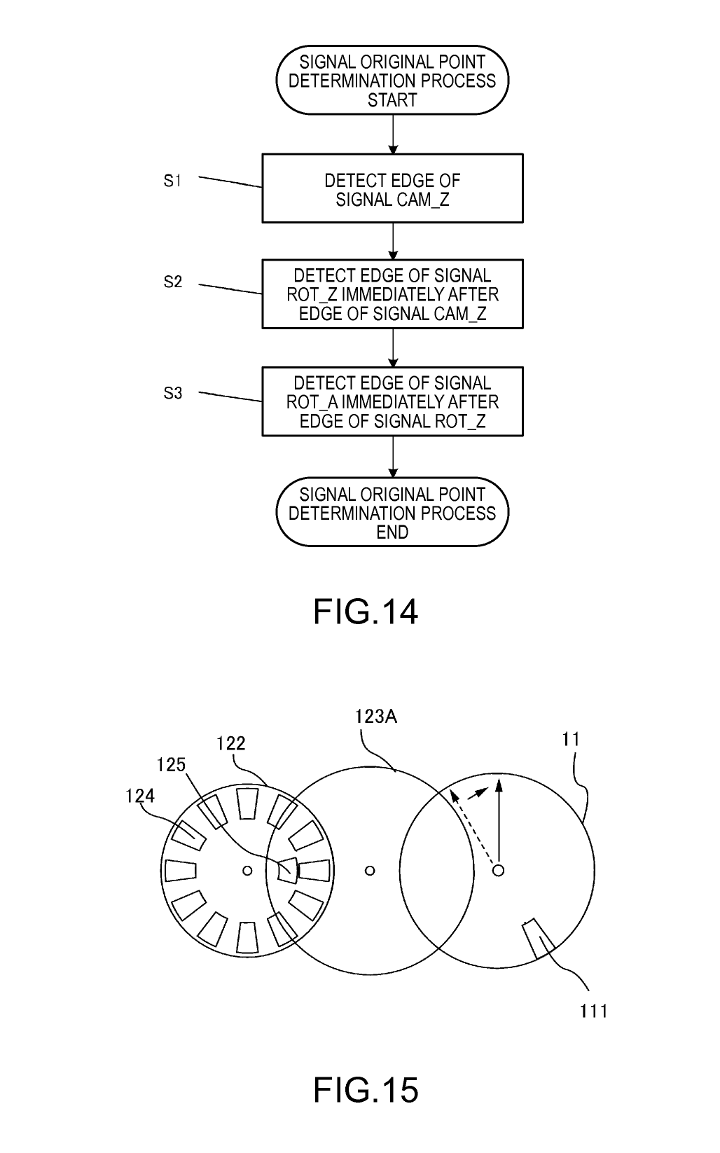

In order to coordinate the signal ROT_A to the cycle of the signal CAM_Z accurately for measuring the rotational angle of the cam. 11 accurately, the edge included in the signal CAM_Z is ideally steep, for example, as illustrated in FIG. 12. Actually, however, the edge of the signal CAM_Z is dull as illustrated in FIG. 13. It is because the rotation of the cam 11 is slower than the rotation of the rotor 112, a change of the signal CAM_Z is gentler than the signal ROT_A. Consequently, timing when the edge included in the signal CAM_Z is detected is slightly deviated depending on the cycle as illustrated by a solid line and a broken line in FIG. 14. Therefore, when an attempt is made to determine the signal original point of the signal ROT_A directly from the signal CAM_Z, reproducibility of the signal original point of the signal ROT_A is low. Therefore, in the embodiment, the signal original points from the signal CAM_Z to the signal ROT_A are determined in the following manner.

FIG. 14 is a flowchart illustrating a procedure for specifying the signal original point of the signal ROT_A. With reference to FIG. 12 as well, specification of the signal original point of the embodiment will be described.

First of all, in Step S1, the control unit 50 detects a leading edge of the pulsed waveform of the signal CAM_Z. Subsequently, in Step S2, the control unit 50 detects an edge of the signal ROT_Z appearing immediately after the detection of the edge of the signal CAM_Z as indicated by an arrow from the signal CAM_Z to the signal ROT_Z in FIG. 12. As described above, the signal ROT_Z is a signal having a cycle of one turn of the rotor 122, timing when the edge of the signal CAM_Z is detected is constant with respect to the signal ROT_Z. Therefore, the edge of the signal ROT_Z is detected with high reproducibility by the process described above. Subsequently, in Step S3, the control unit 50 detects an edge of the signal ROT_A appearing immediately after the detection of the edge of the signal ROT_Z as indicated by an arrow from the signal ROT_Z to the signal ROT_A in FIG. 12, and determines this edge as the signal original point. As described above, since the signal ROT_A and the signal ROT_Z are derived from a light amount of reflected light from the first and second reflecting portions 124 and 125, the first and second reflecting portions 124 and 125 are formed on the rotor 122, and the signal ROT_A corresponds accurately with the cycle of the signal ROT_Z. Therefore, the signal original point of the signal ROT_A is determined with high reproducibility by the process described above.

FIG. 15 is a schematic diagram for explaining pump original point determination. After the determination of the signal original point, a process of determining the pump original point is performed.

First of all, the pump original point is determined. Here, the reference position of the cam 11 described in conjunction with FIG. 9, for example, is determined as the pump original point. The rotational angle of the cam 11 corresponding to the pump original point is obtained by, for example, image processing. Here, the direction of a solid line with an arrow extending from the rotating shaft of the cam 11 in the radial direction in FIG. 15 is assumed to be the rotational angle of the cam 11 corresponding to the pump original point. Then, the rotor 122 is rotated to count edges of the signal ROT_A from the signal original point of the signal ROT_A, and stops rotation of the rotor 122 in a stage in which the cam. 11 reaches a rotational angle corresponding to the pump original point. A counted number of edges Z is stored in the memory unit 52. In this manner, the position on the signal ROT_A corresponding to the pump original point is determined to an edge behind the signal original point by Z.

After the pump original point determination process, the control unit 50 performs the transportation of the liquid as described below. First of all, the control unit 50 drives the piezoelectric actuator 121, rotates the rotor 122 and the cam 11, and detects the edge of the signal CAM_Z. On the basis of the edge of the signal ROT_Z detected immediately after the edge of the signal CAM_Z is detected, the control unit 50 detects an edge of the signal ROT_A (signal original point) detected immediately thereafter. The control unit 50 counts the edges of the signal ROT_A after the detection of the signal original point, and further rotates the rotor 122 and the cam 11 until the counted number of edges reaches the number of edges Z memorized in the memory unit 52. When the counted number of edges reaches the value Z, the cam 11 is located at a rotational angle corresponding to the pump original point. Accordingly, as illustrated in FIG. 9, the control unit 50 rotates the cam 11 at a constant rotational angle during the transportation period from the pump original point (the reference position corresponding to 0 degree in FIGS. 9) to 60 degrees, and rotates to 90 degrees so as to skip the intermittent period upon reaching 60 degrees. Accordingly, the accumulated amount of transportation of liquid can be increased linearly with respect to time. In other words, transportation of liquid with high degree of accuracy is realized.

As described above, in the liquid transport apparatus 1 of the embodiment, on the basis of the edge of the signal ROT_Z detected immediately after the detection of the edge of the signal CAM_Z, the edge of the signal ROT_A detected immediately thereafter is determined as the signal original point of the signal ROT_A. Therefore, variations of the reference position of the signal ROT_A derived from dullness of the edge of the signal CAM_Z may be avoided.

### Others

The embodiment described above is for facilitating the understanding of the invention, and is not for interpreting the invention in a limited range. It is needless to say that the invention may be modified or improved without departing the scope of the invention and equivalents are included in the invention.

The entire disclosure of Japanese Patent Application No. 2014-16649, filed Jan. 31, 2014 is expressly incorporated by reference herein.

What is claimed is:

1. A liquid transport apparatus comprising:
a flow channel forming member configured to form a flow channel in which liquid is transported;
a cam;
a pressing member arranged between the flow channel forming member and the cam, and configured to press the flow channel forming member;
a rotor configured to be rotated by a drive force of an actuator;
a decelerating unit configured to decelerate a rotation of the rotor and transmit the decelerated rotation to the cam;
a cam-side measuring unit configured to output a cam-side reference signal indicating the fact that the cam reaches a predetermined rotational angle;
a first measuring unit configured to output a first signal when the rotor rotates;
a second measuring unit configured to output a second signal indicating the fact that the rotor reaches a predetermined rotational angle and;
a determining unit configured to determine a reference of the first signal on the basis of the second signal output after an output of the cam-side reference signal.

2. The liquid transport apparatus according to claim 1, wherein the cam-side measuring unit outputs a pulse when the cam rotates by one turn.

3. The liquid transport apparatus according to claim 1, wherein the first measuring unit outputs a pulse when the rotor rotates by a predetermined angle, and
the second measuring unit outputs one pulse when the rotor rotates by one turn.

4. The liquid transport apparatus according to claim 1, further comprising:
a counter configured to count on the basis of the first signal; and
a memory unit configured to memorize a counted value counted by the counter from the first signal as a reference until the cam reaches a rotational angle as a reference.

5. The liquid transport apparatus according to claim 1, wherein
the flow channel forming member is a tube, and
the pressing member is a finger.

6. A liquid transport method configured to transport liquid, comprising:
rotating a rotor;
decelerating a rotation of the rotor and transmitting the decelerated rotation to a cam to rotate the cam;
pressing a member that forms a flow channel of liquid in association with the rotation of the cam to transport the liquid;
outputting a cam-side reference signal indicating the fact that the cam reaches a predetermined rotational angle;
outputting a first signal when the rotor rotates;
outputting a second signal indicating the fact that the rotor reaches a predetermined rotational angle;
detecting the fact that the cam reaches the predetermined rotational angle on the basis of the cam-side reference signal;
and determining a reference of the first signal on the basis of the second signal output after an output of the cam-side reference signal.

7. A method of determining a cam original point for an apparatus configured to transport liquid comprising:
rotating a rotor;
decelerating a rotation of the rotor and transmitting the decelerated rotation to a cam to rotate the cam;
pressing a member that forms a flow channel of liquid in association with the rotation of the cam to transport the liquid;
outputting a cam-side reference signal indicating the fact that the cam reaches a predetermined rotational angle;
outputting a first signal when the rotor rotates;
outputting a second signal indicating the fact that the rotor reaches a predetermined rotational angle;
detecting the fact that the cam reaches the predetermined rotational angle on the basis of the cam-side reference signal;
and determining a reference of the first signal on the basis of the second signal output after an output of the cam-side reference signal.
